(19) United States
(12) Patent Application Publication
(10) Pub. No.: US 2007/0280232 A1
(43) Pub. Date: Dec. 6, 2007

(54) Dynamic delivery of multicast service notification messages

(76) Inventors: Wojciech Dec, Amsterdam (NL); Frank Brockners, Koeln (DE)

Correspondence Address: CESARI AND MCKENNA, LLP, 88 BLACK FALCON AVENUE, BOSTON, MA, 02210, US

(21) Appl. No.: 11/443,886

(22) Filed: May 31, 2006

(51) Int. Cl. H04L 12/56

(52) U.S. Cl. 370/390; 370/401

(57) ABSTRACT

A technique dynamically delivers multicast service notification messages in a computer network. According to the novel technique, a service provider (SP) network device determines if it is able to deliver a particular requested multicast service (stream) to a subscriber device, e.g., whether there is enough bandwidth, sufficient quality of service (QoS), appropriate access rights of the subscriber, and/or external triggers, etc. In the event it is unable to deliver the multicast service, the SP network device returns a network-based notification message (e.g., low bandwidth video, audio, data, etc.) using the same communication format as the requested multicast service as though the notification message were the requested multicast service itself. The notification message may be masked such that the subscriber device is substantially unaware that the notification is not the requested multicast service, or the subscriber device may be instructed to display a particular locally cached notification message.

### BACKGROUND OF THE INVENTION

1. Field of the Invention

The present invention relates to computer networks and more particularly to dynamically delivering multicast service notification messages in response to an inability to deliver requested multicast services.

2. Background Information

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

The data packets transferred among the network nodes may include fixed-sized data cells and/or variable-sized data frames. Each data packet typically comprises “payload” data prepended (“encapsulated”) by at least one network header formatted in accordance with a network communication protocol. The network headers include information that enables the client nodes and intermediate network nodes, such as routers, to route the packet efficiently through the computer network. Often, a packet's network headers include at least a data-link (layer 2) header and an internetwork (layer 3) header, as defined by the Open Systems Interconnection (OSI) Reference Model. The OSI Reference Model is generally described in more detail in Section 1.1 of the reference book entitled Interconnections Second Edition, by Radia Perlman, published September 1999, which is hereby incorporated by reference as though fully set forth herein.

In operation, a network node may send a data packet to a network interface of an intermediate network node. Thereafter, the intermediate network node receives the packet and forwards the packet to its next destination. For example, the intermediate network node may perform a layer-2 bridging function that simply re-directs the packet from one network interface to another based on the contents of the packet's data-link header. Alternatively, the intermediate network node may perform a layer-3 routing function, or forwarding decision, that selects the most appropriate network interface to forward the packet based on the contents of the packet's internetwork header.

A source node (sender) may be configured to transfer a unidirectional stream of data packets, or a “data flow,” to a destination node (receiver) in a data network. The data stream is unidirectional in that data travels one-way from the sender to the receiver. The logical procession of intermediate network nodes that transmit and receive data packets from the sender to the receiver defines the data stream's data path. A first node that is nearer the receiver in the data stream's data path than a second node in the stream is said to be “downstream” from the second node. Likewise, a first node that is nearer the sender in the data stream's path than a second node in the stream is said to be “upstream” from the second node.

Some data flows are associated with a certain level of quality of service (QoS). For example, a data flow's QoS may specify minimum end-to-end latency or bandwidth requirements needed to support the flow. The Resource ReSerVation Protocol (RSVP) is a network-control protocol that enables source and destination nodes to “reserve” the necessary resources to establish the data flow in accordance with the flow's required QoS. RSVP works in conjunction with routing protocols to, e.g., reserve resources along a data flow between the source and destination nodes to establish a level of QoS required by the data flow. RSVP is defined in R. Braden, et al., Resource ReSerVation Protocol (RSVP), Request For Comments (RFC) 2205.

“Unicast” data transfer (i.e., unicast forwarding) involves forwarding a data packet from a single sending process of an end node (“source”) to a single receiving process of an end node (“receiver”) on the computer network. Often the destination of the data packet issued by a source may be more than one, but less than all of the receivers on the network. This type of “multicast” data transfer (i.e., multicast forwarding) is typically employed to segregate communication between groups of receivers on the network. IP multicasting, in particular, may be used to disseminate data to a large group of receivers on the network.

To effect IP multicasting, the source generally specifies a destination IP address that is a multicast group address for the message and, as such, can only represent receivers of packets. The IPv4 (or IPv6) address range is subdivided into different prefixes, one of which is designated for use by IP multicast. Receivers typically notify their communication software of their desire to receive messages destined for the multicast group address; this is called “joining a multicast group.” These receiving members then “listen” on the multicast address and, when a multicast message is received at a receiver, it delivers a copy of the message to each process that belongs to the group.

IP multicasting relies on (i) a group management protocol to establish and maintain local multicast group membership, and (ii) multicast routing protocols to route packets efficiently, such as, e.g., Protocol Independent Multicast (PIM). The Internet Group Management Protocol (IGMP) manages packet communication between end nodes, e.g., hosts, and their local intermediate network node, e.g., multicast router, letting them join or leave groups. That is, IGMP is used to send a group membership message from a host to its directly connected router, indicating that the host wants to join a group (address) as a receiver. Note that IGMP is an IPv4 group membership protocol; the conventional Multicast Listener Discovery (MLD) protocol is substantially similar to, and performs the same functions as, IGMP, but for IPv6. When group membership is established, multicast packets (identified by a multicast source (S) and group (G) address in the destination address field of an IP header, or an “(S,G)” address) are forwarded between routers using multicast routing protocols. IGMP is described in RFC 3376, entitled Internet Group Management Protocol, Version 3, by Cain et al., October 2002, which is hereby incorporated herein by reference as though fully set forth herein.

Data packets are used to transport many forms of information over networks and subnetworks. For instance, video information may be transmitted in accordance with Video on Demand (VoD) or Video-over-IP standards known to those skilled in the art. VoD refers to a group of technologies used to transmit video information over data networks from a source node (e.g., a VoD application server) to a destination node (e.g., a VoD application client). The source and destination nodes employ video agents that convert video information from its traditional form to a form that is suitable for packet transmission. In other words, the source node's video agent encodes, compresses, and encapsulates the video information into a plurality of data packets, and the destination node's voice agent performs complementary functions to de-encapsulate, uncompress, and decode the VoD packets. For instance, a VoD content server may supply video data streams to one or more “set-top-boxes” of users. Also, music information may be transmitted in accordance with standards known to those skilled in the art in a similar manner to VoD. Examples of music agents may include personal computers (PCs) running music applications (e.g., streaming audio programs), network devices providing music services (e.g., Internet jukeboxes), etc. Notably, the use of VoD and music services are examples of applications (e.g., at an application layer) that a node within the network may operate. Those skilled in the art will understand that other applications may also be operated at network nodes.

Many service provider networks employ multicast transmissions to send video (e.g., Cable TV), music, data, etc., to their subscribers. This is typically achieved using Ethernet-to-the-home (ETTH), Digital Subscriber Line (DSL), or cable deployment where video, voice, data, etc., are carried to the end users (subscribers). In the ETTH deployment, each video channel, for example, is assigned a unique multicast group address and the video channel is distributed in User Datagram Protocol (UDP) streams to the multicast group address. Each subscriber has a set-top-box that has an IP stack and an IGMP stack. The subscriber, via the set-top-box, sends an IGMP join to a local edge router of the service provider network, which creates the necessary PIM routing states and starts pushing the video streams to the end user. The service provider edge routers are generally part of what is called a “shared access network” or an “aggregation network.” Shared access and aggregation networks are the “pipework” through which the end users (subscribers) reach the core of the service provider networks, e.g., to reach a content server (e.g., the source of the multicast group transmission).

Service providers would like to apply admission control to manage resources, such as bandwidth, in shared access and aggregation networks participating in multicasting services. For instance, bandwidth in the network is not infinite, and is shared by all applications, e.g., video, music, data, etc. Yet, television broadcasts typically consume large amounts of bandwidth, with many networks carrying in excess of two hundred television channels, e.g., through IP multicasting. Those skilled in the art will understand that most bandwidth limitations are found within the “last mile” of the network, e.g., the network resources from the shared access network or aggregation network to the end user (subscriber). As such, resource shortages may sometimes occur in the network, limiting the amount of traffic that may flow over the network at any given time (e.g., preventing multicast service transmission). In addition to resource outages, other network conditions (e.g., poor QoS, high delay, etc.) may result in poor multicast transmissions to the subscribers.

A common approach to control the consumption of resources used to provide IP multicast services (e.g., television) is to actively manage the number of active services (e.g., channels) in the access network. In the event of resource shortages/outages (e.g., bandwidth starvation), no new multicast services are admitted into the access network, so no subscribers are allowed to access those services. For example, if one hundred television channels have been admitted into the access network before a bandwidth shortage occurs, a subscriber attempting to access the one hundred first channel will be unable to do so. Another approach is to provide subscriptions that only allow for subscriber access to a certain subset of available multicast services. If a subscriber attempts to make an unauthorized service selection (e.g., an IGMP join request), the subscriber must be denied access.

When a network device is unable to deliver a requested multicast service (or unable to deliver the service well), the observable behavior to the subscriber typically results in an inability to access the service (e.g., to change the channel if not already there), poor transmission quality, or a black-screen (or silence, etc.), e.g., due to a service outage. Currently, the network devices do not have the ability to report to subscribers the reason for the negative outcome while attempting to join a multicast group (e.g., unauthorized access) or to inform the subscribers of disruptions in service (e.g., bandwidth shortages, or external triggers, such as problems at the source of the service, etc.). As a result, the subscribers are uninformed and may be displeased with the services, possibly leading to additional calls to a service provider's “help desk” (which may incur additional costs for the service provider) and/or lost customers and revenue.

There remains a need, therefore, for a system and method that dynamically delivers multicast service notification messages in response to an inability to deliver requested multicast services. There also remains a need to deliver the notifications without requiring installation of elaborate compatible application software on subscriber devices, and without causing undue burden/load on any one network device (e.g., a centralized content/application server) in the event of a major outage (which may also not be able to reach the subscribers due the outage).

### SUMMARY OF THE INVENTION

The present invention is directed to a technique for dynamically delivering multicast service notification messages in a computer network. According to the novel technique, a service provider (SP) network device determines if it is able to deliver a particular requested multicast service (stream) to a subscriber device, e.g., whether there is enough bandwidth, sufficient quality of service (QoS), appropriate access rights of the subscriber, and/or external triggers, etc. The determination may be made in response to a request by the subscriber device to join a multicast group, or when monitoring a requested multicast service already in session with the subscriber device, or following an externally received trigger or operator instruction during the multicast service. In the event it is unable to deliver the multicast service, the SP network device returns a network-based notification message (e.g., low bandwidth video, audio, data, etc.) using the same communication format as the requested multicast service as though the notification message were the requested multicast service itself. Notably, the notification message may be sourced from the SP network device, or the SP network device may relay the message from an SP notification server, both of which may be masked such that the subscriber device is substantially unaware that the notification is not the requested multicast service. Alternatively, the SP network device may send a data instruction to the subscriber device over the multicast service that instructs the subscriber device to display a particular locally cached notification message.

Advantageously, the novel technique dynamically delivers multicast service notification messages in a computer network. By dynamically returning error notification messages in the requested communication format as though the notification were the requested multicast service, the novel technique allows for efficient and effective subscriber notification of multicast service problems. In particular, the present invention informs subscribers of multicast service problems in a manner that the subscriber device need not distinguish from the expected multicast service (e.g., and possibly without a need for extra configuration on the subscriber devices). Further, by informing the subscriber of the multicast service problem (e.g., as opposed to simply not transmitting the service), the present invention may increase overall subscriber satisfaction.

### BRIEF DESCRIPTION OF THE DRAWINGS

The above and further advantages of the invention may be better understood by referring to the following description in conjunction with the accompanying drawings in which like reference numerals indicate identically or functionally similar elements, of which:

FIG. 1 is a schematic block diagram of an exemplary computer network that may be used in accordance with the present invention;

FIG. 2 is schematic block diagram of an exemplary router that may be advantageously used with the present invention;

FIG. 3 is a schematic block diagram of an exemplary notification message that may be advantageously used with the present invention;

FIGS. 4A and 4B are flowcharts illustrating a procedure for dynamically delivering multicast service notification messages in accordance with the present invention; and

FIG. 5 is a flowchart illustrating a procedure for dynamically returning to delivery of a requested multicast service after delivering notification messages in accordance with the present invention.

### DETAILED DESCRIPTION OF AN ILLUSTRATIVE EMBODIMENT

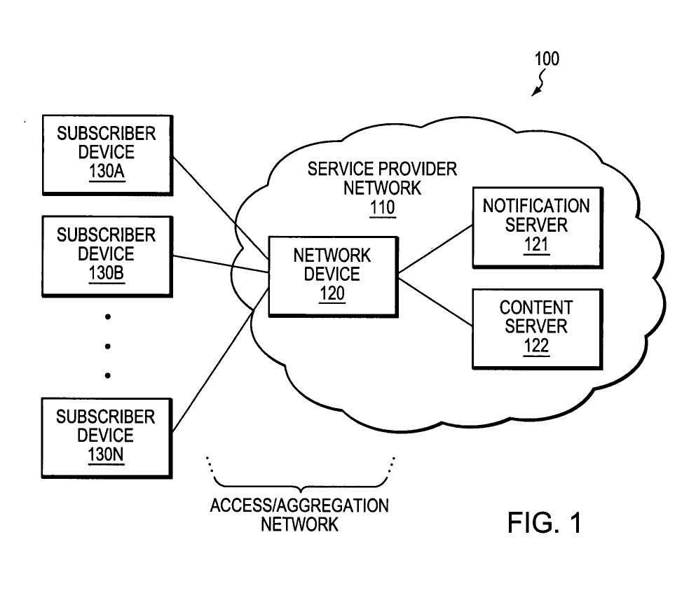

FIG. 1 is a schematic block diagram of an exemplary computer network 100 that may be advantageously used with the present invention. The network 100 comprises a service provider (SP) network 110 (e.g., an Internet SP, “ISP”) having a plurality of interconnected network nodes or devices (“SP network devices”) 120, such as a notification server 121 (described below), content server 122 (e.g., for video, audio, data, etc.), and other SP network devices (not shown). Illustratively, the SP network devices may be interconnected by one or more links, such as, e.g., over wide area network (WAN) links, local area network (LAN) links, etc., to form the service provider network 110. Also, in accordance with the present invention, one or more of the SP network devices are configured for multicast services, as will be understood by those skilled in the art, such that the service provider network is a multicast network. Computer network 100 also comprises one or more subscriber devices (e.g., 130A-N), such as home devices, set-top-boxes, customer premise equipment (CPEs), cable modems, personal computers (PCs), etc. Those skilled in the art will understand that any number of nodes, links, devices, etc., may be used in the computer network 100 and connected in a variety of ways, and that the view shown herein is for simplicity.

Data packets may be exchanged among the devices of the computer network 100 using predefined network communication protocols such as the Transmission Control Protocol/Internet Protocol (TCP/IP), User Datagram Protocol (UDP), Asynchronous Transfer Mode (ATM) protocol, Frame Relay protocol, Internet Packet Exchange (IPX) protocol, etc. For instance, the links connecting the subscriber devices to the network device 120 of the service provider network 110 may utilize, e.g., DSL technology, Cable modems, etc., while the links within the provider network may be ATM, Ethernet, etc., as will be understood by those skilled in the art.

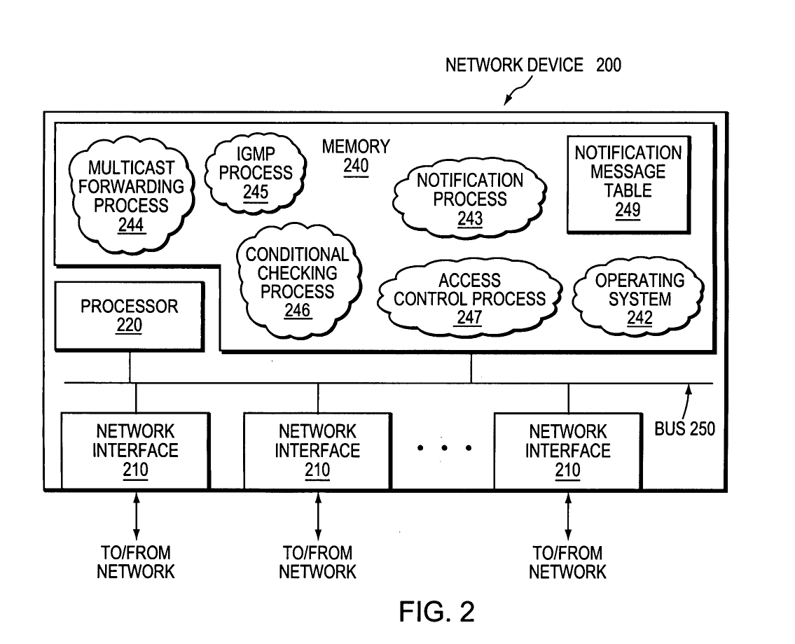

FIG. 2 is a schematic block diagram of an exemplary node 200, which is illustratively a network device that may be advantageously used with the present invention. The network device comprises a plurality of network interfaces 210, a processor 220, and a memory 240 interconnected by a system bus 250. The network interfaces 210 contain the mechanical, electrical and signaling circuitry for communicating data over physical links coupled to the network 100. The network interfaces may be configured to transmit and/or receive data with interconnected network nodes using a variety of different communication protocols, including, inter alia, TCP/IP, UDP, ATM, DSL, synchronous optical networks (SONET), wireless protocols, Frame Relay, Ethernet, Fiber Distributed Data Interface (FDDI), etc.

The memory 240 comprises a plurality of storage locations that are addressable by the processor 220 and the network interfaces 210 for storing software programs and data structures associated with the present invention. The processor 220 may comprise necessary elements or logic adapted to execute the software programs and manipulate the data structures, such as notification message table 249. An operating system 242, portions of which are typically resident in memory 240 and executed by the processor, functionally organizes the router by, inter alia, invoking network operations in support of software processes and/or services executing on the router. These software processes and/or services may comprise notification process 243, multicast forwarding process 244, Internet Group Management Protocol (IGMP) process 245 (notably, and/or Multicast Listener Discovery, MLD process, e.g., for IPv6), conditional checking process 246, and an access control process 247. It will be apparent to those skilled in the art that other processor and memory means, including various computer-readable media, may be used to store and execute program instructions pertaining to the inventive technique described herein.

Multicast forwarding process 244 contains computer executable instructions executed by processor 220 to perform functions provided by one or more routing protocols, such as Protocol Independent Multicast (PIM), PIM-Sparse Mode (PIM-SM), etc. These functions may be configured to cooperate with one or more routing protocols (not shown) that may be used to make routing and forwarding decisions. Also, IGMP process 245 contains computer executable instructions executed by processor 220 to perform conventional IGMP functions described briefly above, as will be understood by those skilled in the art.

The present invention is directed to a technique for dynamically delivering multicast service notification messages in a computer network. According to the novel technique, an SP network device determines if it is able to deliver a particular requested multicast service (stream) to a subscriber device, e.g., whether there is enough bandwidth, sufficient quality of service (QoS), appropriate access rights of the subscriber, and/or external triggers, etc. The determination may be made in response to a request by the subscriber device to join a multicast group, or when monitoring a requested multicast service already in session with the subscriber device, or following an externally received trigger or operator instruction during the multicast service. In the event it is unable to deliver the multicast service, the SP network device returns a network-based notification message (e.g., low bandwidth video, audio, data, etc.) using the same communication format as the requested multicast service as though the notification message were the requested multicast service itself. Notably, the notification message may be sourced from the SP network device, or the SP network device may relay the message from an SP notification server, both of which may be masked such that the subscriber device is substantially unaware that the notification is not the requested multicast service. Alternatively, the SP network device may send a data instruction to the subscriber device over the multicast service that instructs the subscriber device to display a particular locally cached notification message.

Illustratively, the SP network device 120 may be any access or aggregation device that supports at least one of either IGMP processing, multicast forwarding, access control, and conditional checking. For example, the network device may be a DSL Access Multiplexer (DSLAM), a Broadband Remote Access Server (BRAS) router, an Ethernet switch, etc., as will be understood by those skilled in the art. Also, the subscriber device 130 may be any device, e.g., a home device or customer premise equipment (CPE), capable of sending IGMP and receiving multicast traffic, as well as decoding the content of the multicast traffic. For example, the subscriber device may be a set-top-box, a cable modem, a personal computer (PC), etc., as will also be understood by those skilled in the art.

In accordance with one aspect of the present invention, an SP network device 120 may receive a request from a subscriber device 130 (e.g., 130A) for a particular multicast service, for example, a video stream of a particular channel. To determine whether the requested multicast service is deliverable, the network device 120 may utilize a variety of configurable factors. For instance, as described above, a limited amount of bandwidth (BW) may be overloaded, at which point the network device may limit the number of available services (e.g., channels). If the service requested by the subscriber device is available, then the multicast service may be delivered to the requesting subscriber device (e.g., an IGMP join request is allowed), as will be understood by those skilled in the art. Illustratively, conditional checking process 246 may be used to monitor current available bandwidth, or other network conditions that may be useful in determining whether a multicast service may be delivered. Also, the network device 120 may implement an access control process 247 to determine whether the subscriber device 130 has permission or access to receive the requested multicast service. For example, various access control lists (ACLs), service level agreements (SLAs), etc., may be cross-referenced to the particular subscriber device 130 to determine whether the subscriber is allowed to access the service, as will also be understood by those skilled in the art.

Alternatively or in addition, the SP network device 120 of the present invention may also monitor the QoS of a requested multicast service already in session with the subscriber device 130. For instance, conditional checking process 246 may be used to monitor the delay, traffic rate, loss, jitter, etc., of the multicast service transmission to the subscriber device in a manner that will be understood by those skilled in the art. Once the QoS of the service falls below a configurable threshold, a notification message may be triggered by the network device 120 (e.g., to replace an otherwise “poor” transmission). Those skilled in the art will understand that in addition to low bandwidth, denied access, poor QoS, etc., other conditions may exist that may cause the network device 120 to determine that the requested service is undeliverable, e.g., a content server (122) failure, and those conditions mentioned herein are merely representative examples.

Further, one or more other policies, e.g., configured (static) or dynamic policies, may be applied at the SP network device 120 to determine whether the multicast service may be delivered as well. For example, an externally received trigger or operator instruction during the multicast service may inform the SP network device to interrupt delivery of the multicast service and launch notification (described below). The external triggers may be the result of a system operator intervention or policy server direction (or other source external to the SP network device). Example policies may include, e.g., termination of a service due to service “blackouts,” service agreement expirations (e.g., overdue payments, subscription changes, etc.), or other policy-based reasons. Also, more complex policies may be applied to the transmission of multicast services, such as, e.g., prohibiting the distribution of a multicast transmission (e.g., a particular channel) at a particular time (e.g., Monday, from 10:00 PM to 11:00 PM), as will be understood by those skilled in the art.

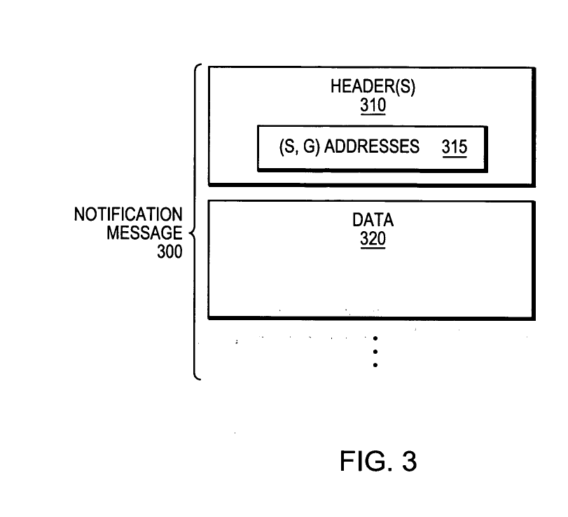

In the event the SP network device 120 is unable to deliver the multicast service to the subscriber device 130 because of, e.g., low bandwidth, denied access, poor QoS, external triggers, operator signaling, etc., the network device returns a network-based notification message to the subscriber using the same communication format as the requested multicast service. FIG. 3 is a schematic block diagram of an exemplary notification message 300 that may be advantageously used with the present invention. Illustratively, the notification message is embodied as an IP multicast data packet, but those skilled in the art will understand that other suitable network transmission formats (e.g., IP unicast) may be used in accordance with the present invention. The message 300 includes one or more headers 310 (e.g., IP/PIM headers, etc.), and a data field 320. Multicast source and group (S,G) addresses 315 within the header 310 are the network multicast identifiers for the source of the multicast stream (e.g., content server 122) and the specific multicast group identifier, as will be understood by those skilled in the art. The (S,G) addresses 315 may be used by the receiving devices (e.g., subscriber devices 130) in a conventional manner, and, for example, by the source or relaying devices (e.g., network device 120) as described below.

The data content of the data field 320 of the notification message may be any encoding of video, audio, data (e.g., error op-code), or combinations thereof, e.g., as described herein. Notably, the content of the message 300 may be matched to the decoding capabilities of the subscriber device(s) 130 to which the message is being sent. For instance, based on the received requests, the SP network device 120 may generate a notification message that corresponds to the encoding of the originally requested multicast service, e.g., a video stream in response to a video request, an audio stream in response to an audio request, etc. In addition, the network device 120 may be configured to return any type of coded message known to be decodable to the subscriber device, such as, e.g., returning a data stream to an audio-requesting subscriber when the subscriber device is capable of decoding audio (as requested) as well as data (as returned).

Assume, for example, that a subscriber is attempting to join a multicast group corresponding to an unavailable video stream (channel). The data field 320 may contain corresponding video code that would display “This channel is temporarily unavailable, please select another channel,” or “We are experiencing technical difficulties, please stand by,” etc. Similar audio and/or data messages may be contained within the data field 320, as will be understood by those skilled in the art. Notably, the notification message may be a low bandwidth message (e.g., requiring considerably lower bandwidth to transmit than the requested multicast service), since an object of the present invention is to inform subscribers of problems that may be the result of insufficient bandwidth. In sum, the notification message 300 contains a multicast (or unicast) stream of data that conveys any configured message to the subscriber of the inability to deliver the requested service, e.g., due to adverse network conditions, access authority, etc. Also, the notifications may be sent to an individual subscriber, such as in the case of a denied access (e.g., “per-subscriber multicast replication”), or to a group of subscribers requesting the same resource, as will be understood by those skilled in the art.

The notification messages 300 may be stored locally to the SP network device 120, e.g., in notification message table 249, or at an SP notification server 121. If the messages are stored at the notification server 121, the network device 120 of the present invention may obtain the messages in a number of ways. One technique for the network device 120 to obtain the messages is to specifically request a corresponding message 300 based on the reason for the notification (e.g., bandwidth, QoS, access, etc.). For instance, the network device 120 may send a one-time request to the notification server 121 for a notification message in response to a bandwidth shortage. The network device 120 may then source (send) the resultant notification message 300 to the subscriber devices 130, e.g., as described below. Another technique for obtaining the messages is for the network device 120 to request that it join a multicast group transmitting the particular messages. For example, the notification server 121 may already be multicasting notification messages 300 over different channels (i.e., groups). The network device 120, then, may request to join the particular group corresponding to the appropriate message (e.g., low bandwidth) in response to determining that a service is not deliverable, and may relay the received messages to the subscriber device 130, e.g., as described below. Different multicast groups (channels) transmitted by the notification server 121, therefore, may correspond to different notification messages 300. In yet another technique for obtaining the messages, the network device 120 may already be receiving the multicast notification messages 300 from the notification server 121, and then may relay the corresponding message to the subscriber device 130, again as described below.

Locally stored messages, on the other hand, may be configured on the network device (e.g., dynamically or by a system administrator), and may each correspond to a particular event (e.g., bandwidth, QoS, access, etc.) accordingly. By storing the messages locally at the network device 120, the present invention alleviates the participation of a centralized notification server 121, e.g., which may be overloaded during large service outages. In addition, destinations within the SP network 110 may be unreachable due to any number of reasons, which may be the cause of the error notification, e.g., if the content server 122 is unreachable, notification server 121 might be as well.

Notably, the notification message 300 may alternatively be configured to instruct the subscriber device 130 to display a locally stored message. For instance, rather than placing an error message (e.g., “Temporarily Unavailable”) in data field 320, as described above, the network device 120 may instead include a code or other indication that is recognizable by a pre-configured subscriber device 130. These codes/indications may be used by the receiving subscriber device to perform a local look-up operation in a similar notification message table 249 to determine which message should be conveyed (e.g., a code instructing the display of: “Temporarily Unavailable”).

In accordance with another aspect of the present invention, the notification message 300 may illustratively use the same communication format as the requested multicast service as though the notification message were the requested multicast service itself. Specifically, notification messages 300 that are sent or relayed from the SP network device 120 may be “masked” to appear to the receiving subscriber devices 130 as though they were the requested multicast service. In particular, when a subscriber device 130 requests a multicast service, e.g., from a request source “Sr” and a requested group (e.g., TV channel) “Or,” the returned messages are expected to have an (S,G) address field 315 of “(Sr,Gr)”, as will be understood by those skilled in the art. As such, the subscriber device “listens” for messages from (Sr,Gr) for the requested multicast service. To “mask” the notification messages 300, then, the present invention translates the address (e.g., (S,G) address field 315) into those of the originally requested multicast service.

For example, assume that the SP network device 120 receives a notification message “M(n)” from the notification server 121 over channel (Sn,Gn). The network device 120, e.g., utilizing a Network Address Translation (NAT) operation, may thus translate the message received on notification channel (Sn,Gn) into the requested channel (Sr,Gr). In other words, the network device 120 receives a multicast service stream over (Sn,Gn), and relays the service stream to the subscriber devices 130 over (Sr,Gr). In this manner, each subscriber device 130, which listens for its requested multicast service, receives the notification message M(n) over channel (Sr,Gr), and therefore displays (plays, etc.) the notification message as though it were the originally requested multicast service, i.e., not aware of the content difference of the incoming multicast stream. The same technique may be applied to locally stored notification messages 300; however, instead of relaying the messages over the requested multicast group/channel (Sr,Gr), the network device 120 creates the notification messages and sources (sends) them to the subscriber devices 130 with the translated (S,G) address field 315.

In addition to translating the (S,G) address field 315, the present invention may also take other measures to mask the transmitted notification message 300 as the requested multicast service. For example, other addresses (e.g., source and destination) or UDP port parameters may be adjusted to correspond to expected addresses and/or ports at the subscriber devices 130, as will be understood by those skilled in the art. The present invention, therefore, attempts to make the notification messages 300 indistinguishable from the originally requested multicast service at the data transport plane. Because the receiving subscriber devices 130 are generally configured to display whatever data is stored in data field 320 of an incoming multicast data stream corresponding to a particular (i.e., requested) (S,G) address, the present invention allows the SP network device 120 to send notification messages 300 to the subscriber devices in response to the requested service being undeliverable. The subscriber device, therefore, may “think” it is receiving the originally requested multicast service, when, in fact, it is receiving the notification message 300 in response to an undeliverable multicast service in accordance with the present invention. In particular, those skilled in the art will appreciate that the present invention masks the network and transport layers of delivery, while allowing a change of the message payload to relay the notification messages. For example, a subscriber may request a “high definition encoded” channel (i.e., utilizing large amounts amount of bandwidth), but due to a reason described herein (e.g., bandwidth limitations), the actual multicast transmission received on that channel is a “low definition” (low bandwidth) notification message.

Notably, a unicast notification message 300 may require a pre-configured subscriber device 130 to allow the receipt of the notification, since the unicast message would be delivered in a manner different than the requested multicast service. In other words, by sending a unicast message in return, the (S,G) address masking described above is unavailable, as will be understood by those skilled in the art, and the subscriber device 130 must be configured to receive and interpret the returned unicast message that is generated by the network device 120 in accordance with the present invention.

In the case where the notification message 300 is alternatively configured to instruct the subscriber device 130 to display a locally stored message (described above), the notification need not utilize the same communication format as the requested multicast service. In other words, an explicit code or other indication may be returned to the subscriber device 130 that is not masked. For instance, rather than adjusting (S,G) addresses to mask the message, the SP network device 120 may send an unmasked notification message 300 to the subscriber device 120, e.g., to a separately monitored delivery channel of the subscriber device.

In accordance with yet another aspect of the present invention, once the network device 120 sending notification messages 300 determines that a change has occurred which would permit the transmission of the originally requested multicast service, the network device may cease transmission of the messages 300, and begin (or resume) transmission of the requested service. For example, bandwidth may have been freed over the access/aggregation network that would allow for the addition of more services (e.g., channels), or a monitored QoS may have improved (e.g., above a second threshold, to avoid oscillations) to a level of acceptable quality. Also, a previously denied access may later be allowed, e.g., purchasing a “pay-per-view” service, etc. In other words, any change in condition that would allow the transmission of the originally requested multicast service may be recognized by the network device, which may respond accordingly by transmitting the multicast service rather than the notification messages.

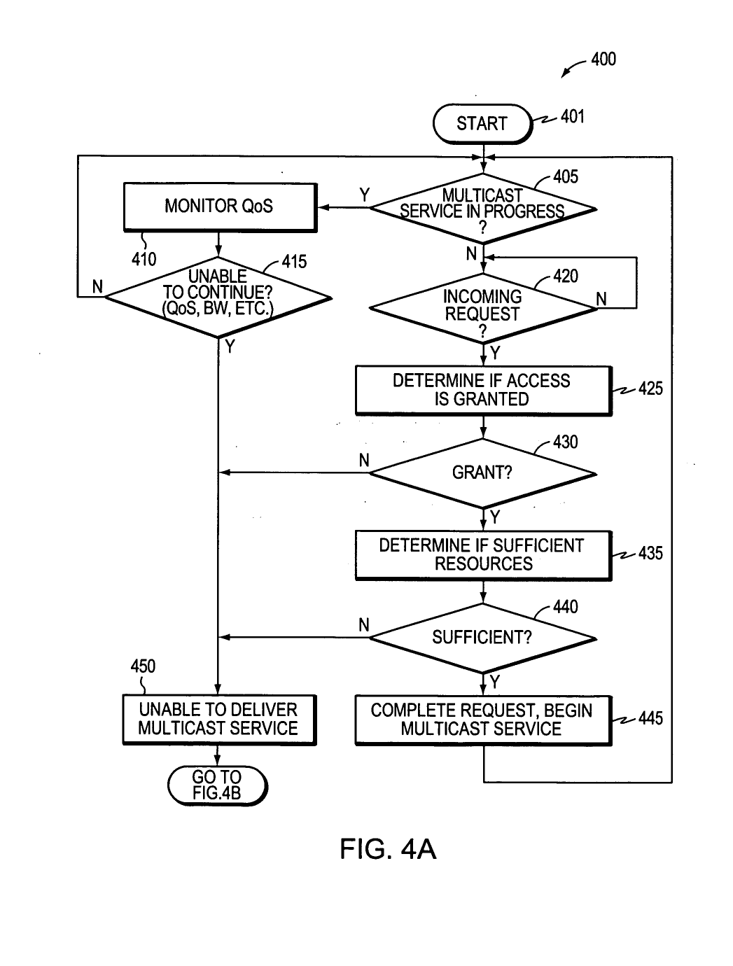

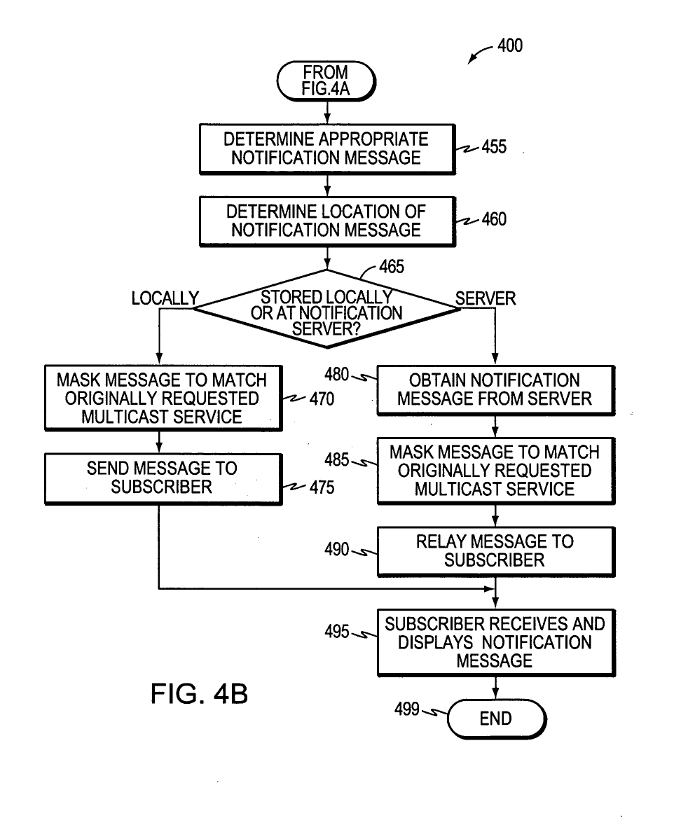

FIGS. 4A and 4B are flowcharts illustrating a procedure for dynamically delivering multicast service notification messages in accordance with the present invention. The procedure 400 starts at step 401, and continues to step 405, where if a multicast service (e.g., video) is already in progress to a subscriber device (e.g., 130A), an SP network device (e.g., 120) that is participating in the delivery monitors the QoS of the delivery in step 410. In the event that the SP network device determines that it is unable to continue the multicast service in step 415, such as, e.g., due to poor QoS, loss of bandwidth, or other network problems addressed above, the delivery is discontinued in step 450, and the procedure continues to FIG. 4B described below. Also at step 415, if the SP network device is triggered to cease transmission of the multicast service (i.e., is unable to continue), e.g., due to an external trigger, such as operator instructions, or other policy-related reasons mentioned above, the delivery is discontinued (step 450), and the procedure continues to FIG. 4B. If the SP network device is able to continue the delivery in step 415, the procedure 400 returns to step 405 (notably, in the event of discontinuation of the multicast service by the subscriber, e.g., channel change).

If at step 405 a multicast service is not already in progress with a subscriber device, the SP network device waits for an incoming multicast service request in step 420. Once a request is received (e.g., a video channel is changed to a new multicast service), the SP network device may determine if access is to be granted to the service in step 425, as mentioned above. If not (step 430), the SP network device is unable to deliver the requested multicast service in step 450, and the procedure continues to FIG. 4B below. If access is granted in step 430, however, the SP network device may also determine whether sufficient resources (e.g., bandwidth) exist to deliver the requested multicast service (e.g., or whether other network conditions would prohibit/restrict delivery) in step 435. If there is not sufficient bandwidth in step 440 (or other adverse network condition), the SP network device is unable to deliver the requested multicast service in step 450, and the procedure continues to FIG. 4B. If, on the other hand, there is enough bandwidth to deliver the multicast service in step 440 (or no adverse network conditions exist), the SP network device completes the request and begins delivering the multicast service to the requesting subscriber device in step 445 (e.g., from content server 122). The procedure 400 then continues to step 405, where if the multicast service is still in progress, the QoS may be monitored in step 410, etc., as described above. Notably, the order with which the SP network device determines deliverability of the multicast service (e.g., access, bandwidth, network conditions, etc.) may be configurable, and the order shown is not limiting to the scope of the present invention.

In the event the SP network device is unable to deliver the requested multicast service in step 450 of FIG. 4A, the procedure 400 continues to step 455 of FIG. 4B, where the SP network device determines the appropriate notification message 300 based on the reason for the inability to deliver the multicast service. For instance, as described above, the notification message may be specific to the cause of the error (e.g., “You do not have access to this service,” or “This service is temporarily unavailable,” etc.). Once the appropriate notification message is determined in step 455, the SP network device 120 next determines the location of the notification message in step 460. If the notification message 300 is stored locally at the SP network device in step 465, the SP network device masks the notification message to match the originally requested multicast service in step 470 as described above. At step 475, the SP network device sends the notification message to the subscriber device as though the notification message were the requested multicast service itself.

If, on the other hand, at step 465 the notification message 300 is stored at an SP notification server (e.g., 121), the SP network device obtains the appropriate notification message from the server in step 480 (e.g., or may already be receiving the message, as mentioned above). At step 485, the SP network device masks the notification message as described above to match the originally requested multicast service. At step 490, the SP network device relays the notification message from the notification server to the subscriber device as though the notification message were the requested multicast service itself.

Upon receiving the notification message 300 (sent or relayed from the SP network device) in step 495, the subscriber device displays (video, audio, data, etc.) the message. Notably, as mentioned above, the subscriber device may be instructed by the notification message to display a particular message stored locally at the subscriber device. The procedure 400 then ends at step 499.

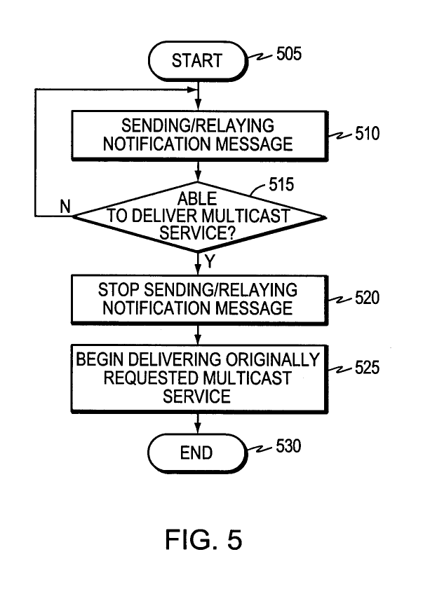

FIG. 5 is a flowchart illustrating a procedure for dynamically returning to delivery of a requested multicast service after delivering notification messages in accordance with the present invention. The procedure 500 starts at step 505, and continues to step 510, where the SP network device 120 is sending/relaying a notification message 300 to one or more subscriber devices 130 as in accordance with FIGS. 4A and 4B above. So long as the SP network device determines that it remains unable to deliver the requested multicast service in step 515 (e.g., poor QoS, denied access, low bandwidth, adverse network conditions, etc.) as mentioned above, the notification message is continually sent to any requesting subscriber device. If, however, at step 515 the SP network device determines that it is now able to deliver the requested multicast service (e.g., acceptable QoS, granted access, added bandwidth, etc.), the SP network device stops sending/relaying the notification message in step 520. The SP network device may then begin delivering the originally requested multicast service to the requesting subscriber device in step 525, and the procedure 500 ends in step 530.

Advantageously, the novel technique dynamically delivers multicast service notification messages in a computer network. By dynamically returning error notification messages in the requested communication format as though the notification were the requested multicast service, the novel technique allows for efficient and effective subscriber notification of multicast service problems. In particular, the present invention informs subscribers of multicast service problems in a manner that the subscriber device need not distinguish from the expected multicast service (e.g., and possibly without a need for extra configuration on the subscriber devices). Further, by informing the subscriber of the multicast service problem (e.g., as opposed to simply not transmitting the service), the present invention may increase overall subscriber satisfaction.

Also, the novel technique advantageously enables multicast transmission error notification directly from the detecting network device to the user (subscriber), notably without utilizing application layer processing at the subscriber devices. Specifically, the novel technique may not require enhanced configuration of the subscriber devices or elaborate application software that must be compatible with the network devices. Instead, as described above with regard to one aspect of the present invention (e.g., content masking), the subscriber devices simply display notification messages as though they were the conventionally received multicast transmissions.

While there has been shown and described an illustrative embodiment that dynamically delivers multicast service notification messages in a computer network, it is to be understood that various other adaptations and modifications may be made within the spirit and scope of the present invention. For example, the invention has been shown and described herein using source specific IGMP join requests and multicasting. However, the invention in its broader sense is not so limited, and may, in fact, be used with multicast networks that do not support source specific multicasting, as will be understood by those skilled in the art. Moreover, while the above description describes performing the technique with a low bandwidth notification message, the present invention may equally utilize regular or high bandwidth messages, such as where bandwidth constraints are not the cause for error (e.g., denied access, etc.), as will also be understood by those skilled in the art.

The foregoing description has been directed to specific embodiments of this invention. It will be apparent, however, that other variations and modifications may be made to the described embodiments, with the attainment of some or all of their advantages. For instance, it is expressly contemplated that the teachings of this invention can be implemented as software, including a computer-readable medium having program instructions executing on a computer, hardware, firmware, or a combination thereof Also, electromagnetic signals may be generated to carry computer executable instructions that implement aspects of the present invention over, e.g., a wireless data link or a data network, such as the Internet. Accordingly this description is to be taken only by way of example and not to otherwise limit the scope of the invention. Therefore, it is the object of the appended claims to cover all such variations and modifications as come within the true spirit and scope of the invention.

What is claimed is:

1. A service provider (SP) network device for use with dynamically delivering multicast service notification messages in a computer network, the SP network device comprising:
a processor adapted to execute software processes; and
a memory adapted to store a notification process executable by the processor, the notification process configured to: i) determine whether the SP network device is able to deliver a particular requested multicast service to a subscriber device, the requested multicast service having a communication format, and ii) in the event the SP network device is not able to deliver the multicast service, return a network-based notification message to the subscriber device using the same communication format as the requested multicast service as though the notification message were the requested multicast service itself.

2. The SP network device as in claim 1, wherein the notification process is further configured to:
mask the notification message as though it were the requested multicast service itself by translating an address of the notification message to match an address of the requested multicast service.

3. The SP network device as in claim 1, further comprising:
one or more network interfaces coupled to the processor and adapted to receive one or more notification messages from an SP notification server.

4. The SP network device as in claim 3, wherein the notification process is further configured to:
request, in response to being unable to deliver the multicast service, the one or more notification messages from the SP notification server.

5. The SP network device as in claim 3, wherein the notification process is further configured to:
return the notification message to the subscriber device by relaying one of the notification messages from the SP notification server to the subscriber device.

6. The SP network device as in claim 1, wherein the memory is further adapted to store one or more notification messages.

7. The SP network device as in claim 1, wherein the notification process is further configured to:
instruct the subscriber device, with the notification message, to convey a particular notification message locally stored at the subscriber device.

8. The SP network device as in claim 1, wherein the notification process is further configured to:
determine an appropriate notification message to return to the subscriber device based on cause of the SP network device not being able to deliver the multicast service.

9. The SP network device as in claim 1, wherein the notification process is further configured to:
determine whether the SP network device is able to deliver the particular requested multicast service in response to a new request for the particular multicast service from the subscriber device.

10. The SP network device as in claim 9, wherein the determination is made based on at least one of an access-based condition, an available bandwidth to the subscriber device, a level of quality of the connection to the subscriber device, network conditions to a source of the multicast service, and one or more policies.

11. The SP network device as in claim 1, wherein the notification process is further configured to:
determine whether the SP network device is able to deliver the particular requested multicast service already in session based on at least one of an available bandwidth to the subscriber device, a level of quality of the connection to the subscriber device, network conditions to a source of the multicast service, and one or more policies.

12. The SP network device as in claim 11, wherein the one or more polices comprise at least one of configured and dynamic policies, the dynamic policies comprising external triggers received at the SP network device from sources external to the SP network device.

13. The SP network device as in claim 1, wherein
the memory is adapted to store a conditional checking process configured to monitor a quality of a multicast service in progress at the SP network device; and
the notification process is further configured to determine whether the SP network device is able to deliver the particular requested multicast service in response to the monitored quality.

14. The SP network device as in claim 1, wherein the memory is further adapted to store at least one of an Internet Group Management Protocol (IGMP) process, a Multicast Listener Discovery (MLD) process, a multicast forwarding process, an access control process, and a conditional checking process.

15. The SP network device as in claim 14, wherein the SP network device is selected from a group comprising: an Ethernet switch, a Broadband Remote Access Server (BRAS) router, and a Digital Subscriber Line Access Multiplexer (DSLAM).

16. The SP network device as in claim 1, wherein the notification process is further configured to:
return the notification message to one of either an individual subscriber device or a group of subscriber devices.

17. The SP network device as in claim 1, wherein the notification process is further configured to:
return the notification message as one of either a unicast message or a multicast message.

18. The SP network device as in claim 1, wherein the notification message is a low bandwidth message.

19. The SP network device as in claim 1, wherein the notification process is further configured to:
match the communication format of the notification message to decoding abilities of the subscriber device.

20. The SP network device as in claim 1, wherein the notification message is of a format selected from a group comprising: video; audio; data; and combinations thereof.

21. A method for dynamically delivering multicast service notification messages in a computer network, the method comprising:
determining whether a service provider (SP) network device is able to deliver a particular requested multicast service to a subscriber device, the requested multicast service having a communication format; and
in the event the SP network device is not able to deliver the multicast service, returning a network-based notification message from the SP network device to the subscriber device using the same communication format as the requested multicast service as though the notification message were the requested multicast service itself.

22. An apparatus for dynamically delivering multicast service notification messages in a computer network, the apparatus comprising:
means for determining whether a service provider (SP) network device is able to deliver a particular requested multicast service to a subscriber device, the requested multicast service having a communication format; and
in the event the SP network device is not able to deliver the multicast service, means for returning a network-based notification message from the SP network device to the subscriber device using the same communication format as the requested multicast service as though the notification message were the requested multicast service itself

23. A computer readable medium containing executable program instructions for delivering multicast service notification messages in a computer network, the executable program instructions comprising program instructions for:
determining whether a service provider (SP) network device is able to deliver a particular requested multicast service to a subscriber device, the requested multicast service having a communication format; and
in the event the SP network device is not able to deliver the multicast service, returning a network-based notification message from the SP network device to the subscriber device using the same communication format as the requested multicast service as though the notification message were the requested multicast service itself.

24. A system for use with dynamically delivering multicast service notification messages in a computer network, the system comprising:
a subscriber device configured to request and receive multicast services; and
a service provider (SP) network device configured to i) determine whether the SP network device is able to deliver a particular requested multicast service to a subscriber device, the requested multicast service having a communication format, and ii) in the event the SP network device is not able to deliver the multicast service, return a network-based notification message to the subscriber device using the same communication format as the requested multicast service as though the notification message were the requested multicast service itself

25. The system as in claim 24, further comprising:
an SP notification server configured to store and transmit one or more notification messages, wherein the SP network device is further configured to receive the one or more notification messages from the SP notification server and to return the notification message to the subscriber device by relaying one of the one or more notification messages from the SP notification server to the subscriber device.
